(19) United States
(12) Patent Application Publication
(10) Pub. No.: US 2014/0167340 A1
(43) Pub. Date: Jun. 19, 2014

(54) BUMP STOPPER

(71) Applicant: HYUNDAI MOTOR COMPANY, Seoul (KR)

(72) Inventor: Tae Hyung Kim, Seoul (KR)

(73) Assignee: Hyundai Motor Company, Seoul (KR)

(21) Appl. No.: 13/804,743

(22) Filed: Mar. 14, 2013

(30) Foreign Application Priority Data
Dec. 17, 2012 (KR) 10-2012-0147926

(51) Int. Cl. B60G 11/22

(52) U.S. Cl. CPC B60G 11/22
USPC 267/292

(57) ABSTRACT

Disclosed herein is a bump stopper that includes a connecting portion formed on a bottom of a vehicle frame. The connecting portion includes an empty space formed therein and a fitting guide that is partially cut on the bottom. The bump stopper additionally includes an elastic member that includes a plurality of protrusions fitted in the fitting guide and extending at the top in the longitudinal direction of the frame to be fixed in the fitting guide.

### CROSS-REFERENCE TO RELATED APPLICATION

This application claims under 35 U.S.C. §119(a) the benefit of Korean Patent Application No. 10-2012-0147926 filed Dec. 17, 2012, the entire contents of which are incorporated herein by reference.

### BACKGROUND

(a) Technical Field

The present invention relates to a bump stopper disposed on a vehicle body configured to control the amount of bumping in a wheel stroke in a suspension of a vehicle.

(b) Background Art

The suspension of vehicles is a system configured to improve driving comfort by absorbing an impulsive force by connecting the vehicle body with a wheel and is usually implemented by fixing rubber 20 vulcanized to steel 30 on a vehicle frame 10 to a bracket 40 with bolts and nuts 50. However, as seen in FIG. 1, the rubber 20 may be deformed or durability and performance of the bump stopper may deteriorate when the frame 10 to which the bump stopper is mounted is painted. Generally, the painting process is performed prior to mounting the bracket 40, thus the heat from the painting process may damage the rubber 20. In particular, the bump stopper may be mounted on a top of a leaf spring or a bottom of a frame with bolts based on the layout with respect to the position of the axle center in conventional vehicles.

In a conventional bump stopper, a shock-absorbing member is configured in a double structure by overlapping upper rubber and lower rubber and combining the rubber with bolts and nuts, to increase durability and shock-absorbing ability. However, with an increase in space for assembling, the strength of the bump stopper that absorbs a shock from the ground must be increased, and when the frame has a U-shape and a floor is mounted on the top, the frame is substantially closed, omitting the separate space for needed for assembly and mounting of the bump stopper.

The description provided above as a related art of the present invention is just for helping understanding the background of the present invention and should not be construed as being included in the related art known by those skilled in the art.

### SUMMARY

The present invention provides a bump stopper that is capable of being mounted to various vehicle frame shapes and various parts may be eliminated to reduce the cost of the product while maintaining the performance of the bump stopper. Specifically, the present invention provides a bump stopper that may include: a connecting portion formed on the bottom of a vehicle frame and may include an empty space therein and a fitting guide partially cut on the bottom; and an elastic member having a plurality of protrusions fitted in the fitting guide and extending at the top in the longitudinal direction of the frame to be fixed in the fitting guide.

The width of the connecting portion may be set smaller than the width of the frame and the length of the connecting portion may extended to the longitudinal direction of the frame. The cross-section of the connecting portion may be a rectangle. The fitting guide may be a rectangle. The connecting portion may have substantially curled portions formed by bending the edges in the width direction of the fitting guide outward from the interior of the fitting guide. The longitudinal width of the fitting guide may be smaller than the longitudinal width of the elastic member.

The elastic member may be combined with the connecting portion, corresponding to the connecting portion, and the thickness of the protrusions of the elastic member may be the same as the depth of the connecting portion. The elastic member may be formed in a trapezoidal shape. In addition, an aperture may be formed through the elastic member in the width direction of the elastic member. The aperture may be formed in a triangular shape with rounded apexes, which is inclined opposite to the outer inclination of the elastic member. The elastic member may be rubber.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary view showing a bump stopper according to the related art;

FIG. 2 is an exemplary view showing a bump stopper according to an exemplary embodiment of the present invention;

FIG. 3 is an exemplary front view of FIG. 2 according to an exemplary embodiment of the present invention;

FIG. 4 is an exemplary view showing an elastic member according to an exemplary embodiment of the present invention;

FIG. 5 is an exemplary view showing a connecting portion according to an exemplary embodiment of the present invention;

FIG. 6 is an exemplary front view of FIG. 5 according to an exemplary embodiment of the present invention;

FIG. 7 is an exemplary view showing the portion A of FIG. 6 in detail according to an exemplary embodiment of the present invention; and

FIG. 8 is an exemplary table showing the result of testing durability of a bump stopper according to an exemplary embodiment of the present invention.

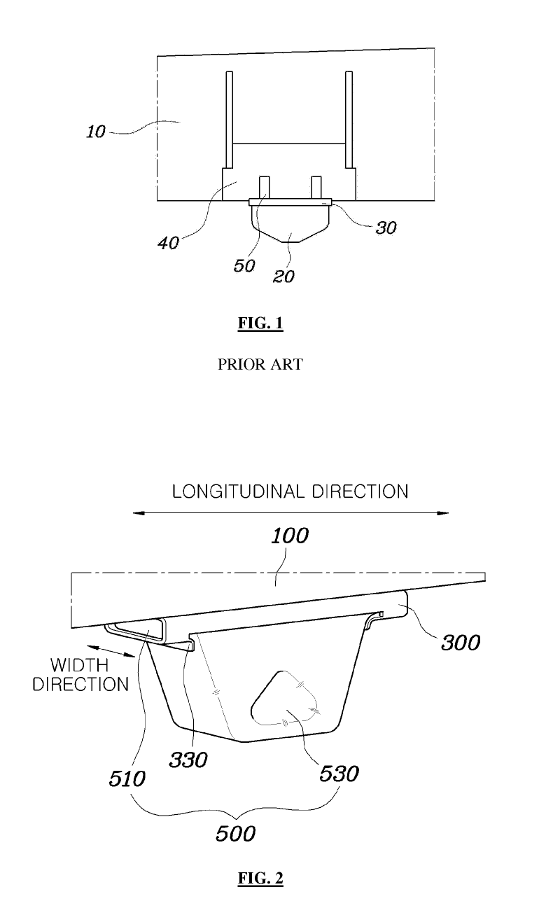

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

A bump stopper according to exemplary embodiments of the present invention is described hereafter with reference to the accompanying drawings.

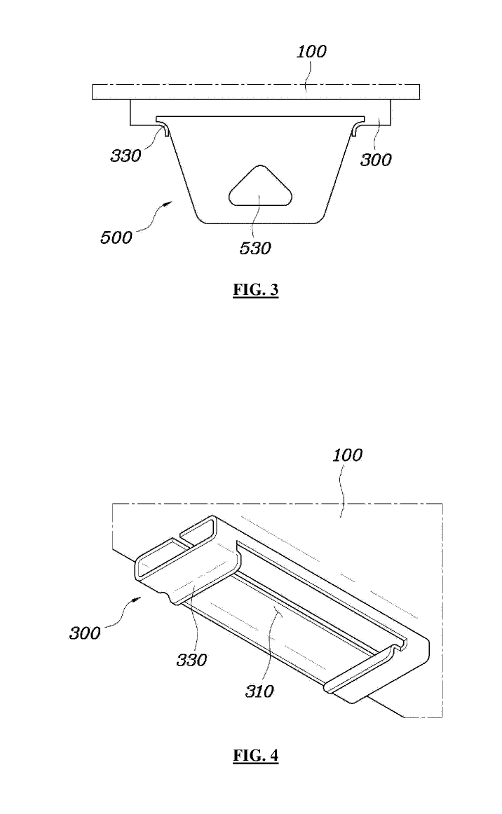

FIGS. 2 to 7 are exemplary views showing a bump stopper according to an exemplary embodiment of the present invention. FIG. 2 is an exemplary view of the bump stopper and FIG. 3 is an exemplary front view. FIGS. 4 to 7 are exemplary views showing parts of the bumper stopper in detail.

A bump stopper according to an exemplary embodiment of the present invention may include: a connecting portion 300 formed on the bottom of a vehicle frame 100 and may include an empty space therein and a fitting guide 310 partially cut on the bottom; and an elastic member 500 having a plurality of protrusions 510 fitted in the fitting guide 310 and extending at the top in the longitudinal direction of the frame 100 to be fixed in the fitting guide 310.

As shown in FIG. 4, the width of the connecting portion 300 may be set smaller than the width of the frame 100 and the length of the connecting portion 300 corresponds to the longitudinal direction of the frame 100. The connecting portion 300 may be formed integrally or separately on the bottom of the frame 100, but is exemplified as being integrally formed in the exemplary embodiment. The connecting portion 300 may be formed by bending both ends of a flat panel made of the same material as that of the frame 100 to connect the ends, forming a rectangular cross-section, and an empty space therebetween.

The portion where both ends of the flat panel are connected may be the top of the connecting portion 300 which is in contact with the bottom of the frame 100 to be combined with the frame. In addition, the fitting guide 310 may be formed by cutting the bottom of the connecting portion 300 to be smaller than the width and the length of the connecting portion 300. The fitting guide 310 may have a rectangular shape and the width of the fitting guide 310 may be set to the same width as the connecting portion 300. FIG. 4 shows the fitting guide 310 formed up to the sides of the connecting portion 300. The connecting portion 300 may have substantially curled portions 330 formed by bending the edges in the width direction of the fitting guide 310 outward from the interior of the fitting guide 310 at a predetermined distance.

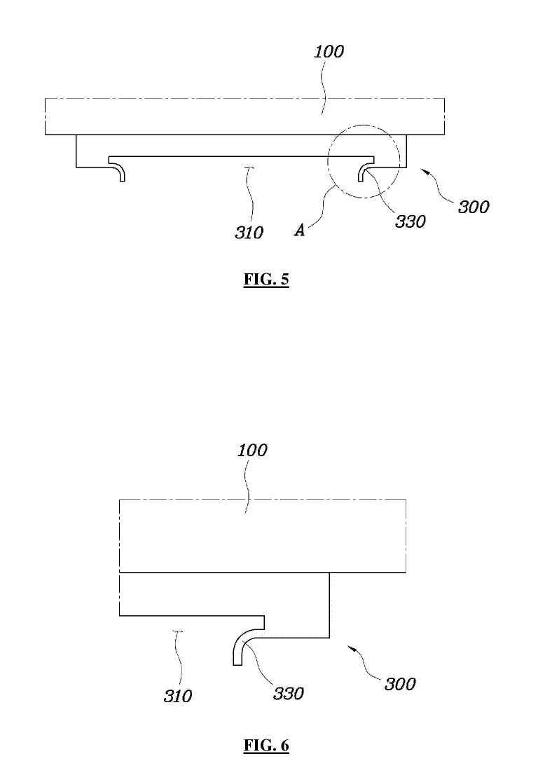

FIGS. 5 and 6 show the substantially curled portion 330 in detail. The substantially curled portions 330 operate as guides when the elastic member 500 is fitted, and are configured to prevent the elastic member 500 from tearing by contacting the edges of the fitting guide 310 after the elastic member 500 is fitted in the connecting portion 300, even when the elastic member 500 is moved by vibration generated or transmitted from a vehicle.

Further, since the elastic member 500 may be fitted into the connecting portion 300 through the fitting guide 310, the longitudinal width of the fitting guide 310 may be set smaller than the longitudinal width of the elastic member 500. In addition, since the protrusions 510 of the elastic member 500 are fitted portions other than the fitting guide 310 of the connecting portion 300, the thickness of the protrusions 510 of the elastic member 500 may be substantially the same as the depth of the connecting portion 300.

Referring to FIG. 7 showing the elastic member 500 in detail, the elastic member 500 may made of rubber in various shapes, the elastic member 500 according to an exemplary embodiment of the present invention is formed in trapezoidal shape to exhibit optimal performance in vibration attenuation. In addition, an aperture 530 may be formed formed through the elastic member 500 in the width direction of the elastic member, in which the aperture 530 may be formed in a triangular shape with the rounded apexes, which is inclined opposite to the outer inclination of the elastic member 500 to reduce load concentration and stress.

Since the elastic member 500 may be fitted in the separate connecting portion 300 by elastic force, assembling not influenced by the shape of the frame, thus, the elastic member 500 may be mounted on various shapes of frames and combined after painting, to prevent damage to the elastic member due to heat and the durability of the performance is not reduced during this process. Further, since a specific vulcanized bracket or bolts and nuts are omitted in the present invention, the manufacturing processes may be reduced, the structure may be simplified, the number of parts may be reduced, thus reducing the overall cost of the product. In particular, it may be possible to maintain rigidity of the frame due to a separate space for assembling to mount the bump stopper on the frame being omitted.

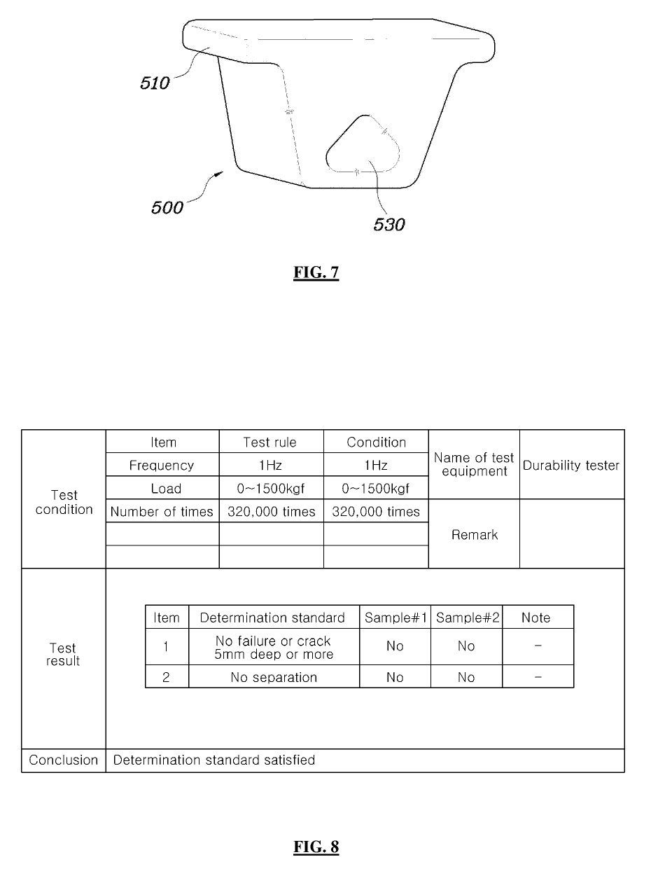

FIG. 8 is an exemplary table showing the result of testing durability of a bump stopper according to an exemplary embodiment of the present invention, which was performed to determine whether the bumping amount may be effectively controlled in a wheel stroke.

The experiment was repeated 320,000 times under the frequency of vibration of 1 Hz and load of 0˜1500 kgf from under the bump stopper with a durability tester. According to the result of the test, failure did not occur, separation did not occur, and cracks formed were less than 5 mm deep, thus satisfying the determination standard under test rules.

As seen from the test result, the bump stopper according an exemplary embodiment of the present invention may be mounted to various shapes of frames, the assembly processes decrease, and the structure is simplified compared to the related art, due to the elimination of a vulcanized bracket or bolts and nuts, and the performance of the frame may be maintained.

According to the bump stopper having the structure described above, since the bump stopper is not limited to a particular shape of frame, it may be mounted with various frames when mounted on the exterior of a vehicle. Further, an elastic member may be connected with a connecting portion using elastic force even after painting, thus preventing the elastic member from being damaged due to heat.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A bump stopper comprising:
a connecting portion formed on a bottom of a vehicle frame , wherein the connecting portion includes an empty space formed therein and a fitting guide partially cut on the bottom; and
an elastic member having a plurality of protrusions fitted in the fitting guide and extending at the top in the longitudinal direction of the frame to be fixed in the fitting guide.

2. The bump stopper of claim 1, wherein the width of the connecting portion is smaller than the width of the frame and the length of the connecting portion corresponds to the longitudinal direction of the frame.

3. The bump stopper of claim 1, wherein the cross-section of the connecting portion is a rectangle.

4. The bump stopper of claim 1, wherein the fitting guide is a rectangle.

5. The bump stopper of claim 1, wherein the connecting portion includes a plurality of substantially curled portions formed by bending the edges of the connecting portion in the width direction of the fitting guide outward from the interior of the fitting guide.

6. The bump stopper of claim 1, wherein the longitudinal width of the fitting guide is smaller than the longitudinal width of the elastic member.

7. The bump stopper of claim 1, wherein the elastic member is combined with the connecting portion, and the thickness of the plurality of protrusions of the elastic member is substantially the same as the depth of the connecting portion.

8. The bump stopper of claim 1, wherein the elastic member is formed in a trapezoidal shape.

9. The bump stopper of claim 1, wherein an aperture is formed through the elastic member in the width direction of the elastic member.

10. The bump stopper of claim 1, wherein the aperture is formed in a triangular shape with rounded apexes, which is inclined opposite to the outer inclination of the elastic member.

11. The bump stopper of claim 1, wherein the elastic member is rubber.
